(19) United States
(12) Patent Application Publication
(10) Pub. No.: US 2005/0084570 A1
(43) Pub. Date: Apr. 21, 2005

(54) Ready-to-bake dough and integrated baking sheet

(75) Inventor: Angela L. Fairhurst, Los Angeles, CA (US)

Correspondence Address: QUINTERO LAW OFFICE, 1617 BROADWAY, 3RD FLOOR, SANTA MONICA, CA, 90404, US

(73) Assignee: MICHAEL GREENE, TOPANGA, CA (US)

(21) Appl. No.: 10/878,764

(22) Filed: Jun. 28, 2004

Related U.S. Application Data
(60) Provisional application No. 60/513,341, filed on Oct. 21, 2003.

(51) Int. Cl. A23B 4/00

(52) U.S. Cl. 426/128

(57) ABSTRACT

A dough product with integrated baking sheet. Ready-to-bake refrigerated or frozen dough is wrapped in a baking sheet made of flexible material. The amount of dough and the dimensions of the baking sheet are proportioned such that when the dough is wrapped, the dough is contained in the baking sheet, and when the dough is unwrapped and formed into one or more dough pieces, the dough pieces may be arranged on the baking sheet for baking.

This application claims the benefit of U.S. Provisional Application 60/513,341, filed on Oct. 21, 2003, which is hereby incorporated by reference.

### BACKGROUND OF THE INVENTION

1. Field of the Invention

This invention relates to baked foods. More particularly, this invention relates to ready-to-bake dough and an integrated baking sheet.

2. Description of the Related Art

Baked foods, for example cookies, are a special treat for all. Conventional ready for baking dough products provide an alternative to traditional mixing and baking and reduce the overall preparation and baking time.

Typically, refrigerated or frozen ready for baking cookie dough is provided in a plastic tube. A spoon or knife is used to shape and dispose a dozen or more discrete pieces of cookie dough on a metal cookie sheet or tray for baking in a conventional oven at 350 degrees Fahrenheit.

However, preheating a conventional oven to 350 degrees Fahrenheit is time consuming. Furthermore, the metal cookie sheet or tray for baking the cookies should be cleaned and stored after each use. In addition, unless dozens of cookies are prepared at one time, the remaining cookie dough must be rewrapped and refrigerated for later use. While the shelf life of conventional ready for baking cookie dough is several months in an unopened container, any cookie dough remaining after opening should be used within one week. In the conventional art, the remaining cookie dough may be wasted when only a small number of fresh baked cookies are desired.

Thus, there is a need for inexpensive ready-to-bake dough products suitable for the baking of small or individual portions with faster bake times, reduced mess, and ease in making.

### SUMMARY

To answer the demand for small or individual portions of easy to prepare fresh baked dough products and to address current shortcomings of existing products, the present invention provides a baking pack comprising ready-to-bake dough and an integrated baking sheet. The ready-to-bake dough and integrated baking sheet of the present invention are beneficially made for the individual who desires a small or individual portion of fresh baked goods.

In a preferred embodiment of the present invention, a baking pack is provided comprising ready-to-bake dough and an integrated flexible baking sheet configured to be flattened and received in a toaster oven, wherein the dough is packaged in the baking sheet. The dough is preferably ready-to-bake refrigerated or frozen cookie dough. It is understood, however, that any ready-to-bake dough suitable for baking on a flat surface may also be utilized. In one embodiment of the invention, the dough is wrapped in the baking sheet, wherein the amount of dough and the dimensions of the baking sheet are proportioned such that when the dough is wrapped, the dough is contained in the baking sheet, and when the dough is unwrapped and formed into one or more dough pieces, the dough pieces may be arranged on the baking sheet for baking.

The baking pack of the present invention may advantageously include an outer wrap, wherein the dough is first wrapped in the integrated baking sheet and then wrapped in the outer wrap. Alternately, an inner wrap may be provided, wherein the dough is first wrapped in the inner wrap and then wrapped in the integrated baking sheet.

The present invention further provides a process of preparing packaged dough integrated with a baking sheet suitable. In the method of the present invention, ready-to-bake dough in an amount to make a small or individual portion of baked goods is wrapped in a flexible baking sheet. The amount of dough and the dimensions of the baking sheet are proportioned such that when the dough is wrapped, the dough is contained in the baking sheet, and when the dough is unwrapped and formed into one or more dough pieces and the baking sheet flattened, the dough pieces may be arranged on the baking sheet for baking.

In a preferred embodiment of the present invention, multiple individually wrapped baking packs are packaged together in a carton such that a total of one, two, three or other desired number of pounds of ready-to-bake dough are provided. When a small or individual portion of baked goods is desired, only a single baking pack need be opened, thus preserving the shelf life of unused dough.

### BRIEF DESCRIPTION OF THE DRAWINGS

These and other features, aspects, and advantages of the present invention will become better understood with regard to the following description, appended claims, and accompanying drawings, where:

FIG. 1 shows a perspective view of four baking packs packaged in a carton according to one embodiment of the present invention.

FIG. 2 shows a perspective view of a single baking pack in a parallelepipedal configuration.

FIG. 3 shows a perspective view of the single baking pack of FIG. 2 wherein the baking sheet is unwrapped and the ready-to-bake dough disposed on top of the baking sheet.

FIG. 4 shows a perspective view of the single baking pack shown in FIG. 3 with the ready-to-bake dough divided into pieces and arranged on the baking sheet.

FIG. 5 shows a cross-sectional view of a baking pack according to another embodiment of the present invention.

### DESCRIPTION

The baking pack of the present invention provides ready-to-bake dough and an integrated baking sheet preferably made for the individual who desires a small or individual portion of fresh baked goods. According to one embodiment of the present invention, the baking pack comprises refrigerated or frozen ready-to-bake dough in an amount sufficient for making a small or individual portion of baked goods and an integrated flexible baking sheet configured to be flattened and received in a toaster oven, wherein the dough is packaged in the baking sheet. The amount of dough and the dimensions of the baking sheet are proportioned such that when the dough is wrapped, the dough is contained in the baking sheet, and when the dough is unwrapped and formed into one or more dough pieces, the dough pieces may be arranged on the baking sheet for baking.

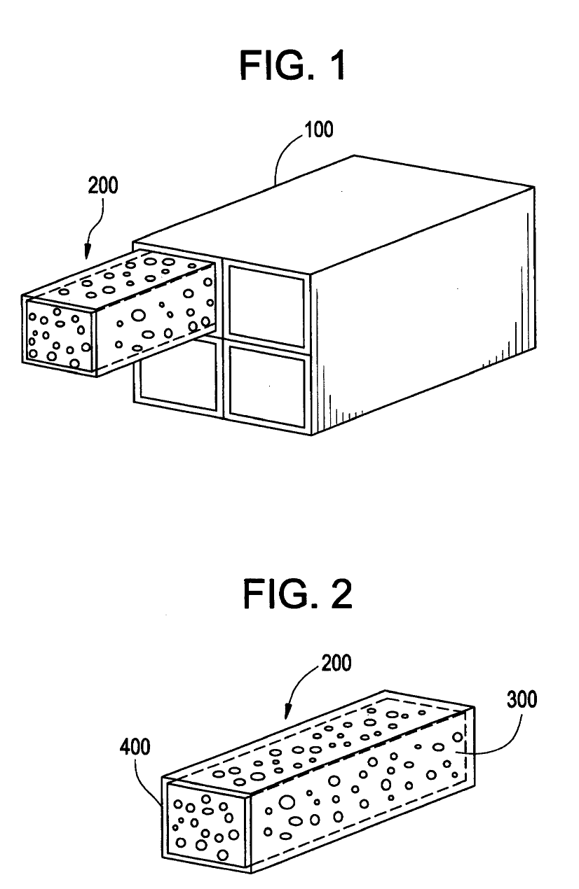

The baking packs of the present invention may be sold individually or packaged together in a container that is to be kept in the refrigerator or freezer. In preferred embodiments in which multiple baking packs are packaged together in a carton, the baking packs can be packaged in groups of four, eight, sixteen or other suitable number such that the carton includes a total of one, two, three or other desired number of pounds of ready-to-bake dough. FIG. 1 shows one possible configuration of the invention in which a carton 100 includes four baking packs. In a preferred embodiment in which each baking pack comprises about four ounces of cookie dough, the carton would thus include about one pound of cookie dough. The carton can be made of synthetic material, cardboard, paper or other suitable material for withstanding refrigeration and/or freezing and providing protection against air and moisture.

FIG. 2 shows a baking pack 200 of one embodiment of the present invention. In FIG. 2, the baking pack 200 is a parallelepipedal configuration. However, it is to be understood that in alternate embodiments, the baking packs may be a cylindrical, spherical, prismatic or other configuration. Baking pack 200 includes ready-to-bake dough 300 in an amount sufficient for making a small or individual portion of baked goods and an integrated baking sheet 400 made of flexible material suitable for baking. As shown in FIG. 2, ready-to-bake dough 300 is packaged in baking sheet 400.

Ready-to-bake dough 300 preferably comprises ready-made cookie dough of any recipe suitable for storing in a refrigerator or freezer. The dough is provided in a sufficiently solid or semi-solid state and is prepared and molded using conventional devices. In embodiments of the invention, roughly one to eight ounces of dough are provided, more preferably three to five ounces. In a preferred embodiment of the invention, baking pack 200 comprises approximately three to five ounces of cookie dough prepared to be broken into three to five dough pieces of predetermined size using grooves, score lines or a combination thereof. The predetermined size should be sufficiently large to provide a desired baked cookie. The grooves and/or score lines can be formed using marker rolls or other devices known in the art. Optionally, the cookie dough may contain inclusions such as chocolate pieces, nuts, raisins, or mixtures thereof. While the invention has been exemplified with cookie dough, it is to be understood that the invention is applicable to other ready-to-bake dough suitable for baking on a flat surface.

Baking sheet 400 is preferably made of silicon paper. Silicon paper comprises paper or parchment treated on one or both sides with silicon to produce a non-stick heat-resistant sheet, wherein a dual-sided coating is preferable. In alternate embodiments, baking sheet 400 may be shiny aluminum foil, dark aluminum foil, stainless steel foil, a non-stick baking sheet, or laminates thereof. It is to be understood, however, that other materials suitable for withstanding freezing and baking in a toaster oven may be used. In one embodiment of the present invention, the baking sheet is reusable. The thickness of the baking sheet is a function of the material used and flexibility required to allow for wrapping and unwrapping the dough.

Ready-to-bake dough 300 is wrapped in baking sheet 400 using conventional techniques known in the art. In a preferred embodiment, ready-to-bake dough 300 is beneficially wrapped in baking sheet 400 to protect the dough from air and moisture by folding the baking sheet about the cookie dough, as is known with a typical individually wrapped stick of butter. In some embodiments of the present invention, opposite edges of the baking sheet may overlap when folded about the ready-to-bake dough 300 to allow for a larger baking surface when the baking sheet is flattened.

In baking pack 200, the amount of ready-to-bake dough 300 and the dimensions of the baking sheet 400 are proportioned such that when the ready-to-bake dough 300 is wrapped, the dough is contained in the baking sheet 400, and when the dough is unwrapped and formed into one or more dough pieces, the baking sheet is of sufficient size such that the dough pieces may be arranged on the baking sheet 400 for baking. In preferred embodiments of the invention, the dough is shaped to have a height and width sufficient to form a cookie of edible size upon baking with minimal or no further manipulation of the dough after cutting or breaking the dough into pieces along the lengthwise axis. When grooves and/or score lines are provided in the dough along the lengthwise axis, dough pieces obtained by separating the dough at the grooves and/or score lines are preferably ready for baking with no need for further manipulation of the dough by rolling, cutting or folding. The baking sheet 400 is most preferably proportioned such that when it is flattened, it can be received in a conventional toaster oven without further manipulation.

In an exemplary embodiment, roughly three to five ounces of ready-to-bake dough are shaped into a parallelepipedal configuration having a length of about 4 to 6 inches, a height of about 1 to 1.5 inches, and a width of about 1 to 1.5 inches. In this embodiment, the baking sheet 400 is preferably formed in a rectangular configuration with a length of about 5 to 7 inches and a width of about 4 to 6 inches, wherein the dough is wrapped lengthwise in the baking sheet. In another exemplary embodiment, roughly five to eight ounces of ready-to-bake dough are shaped into a parallelepipedal configuration having a length of about 6 to 9 inches, a height of about 1 to 1.5 inches, and a width of about 1 to 1.5 inches. In this embodiment, the baking sheet 400 is preferably formed in a rectangular configuration with a length of about 7 to 10 inches and a width of about 4 to 6 inches, wherein the dough is wrapped lengthwise in the baking sheet. In yet another exemplary embodiment, roughly three to five ounces of ready-to-bake dough are shaped into a parallelepipedal configuration having a length of about 4 to 5 inches, a height of about 1 to 1.5 inches, and a width of about 1 to 1.5 inches. In this embodiment, the baking sheet 400 is preferably formed in a rectangular configuration with a length of about 7 to 10 inches and a width of about 5 to 6 inches, wherein the dough is wrapped by the baking sheet crosswise such that the baking sheet overlaps along its lengthwise axis. It is to be understood, however, that the shaped ready-to-bake dough 300 and the baking sheet 400 may be provided in other suitable amounts, shapes and dimensions, wherein the amount of dough and the dimensions of the baking sheet are such that the dough can be wrapped in the baking sheet for storage, and when the dough is unwrapped and formed into one or more dough pieces, the baking sheet when flattened is of sufficient size to allow the arrangement of the dough pieces thereon for baking.

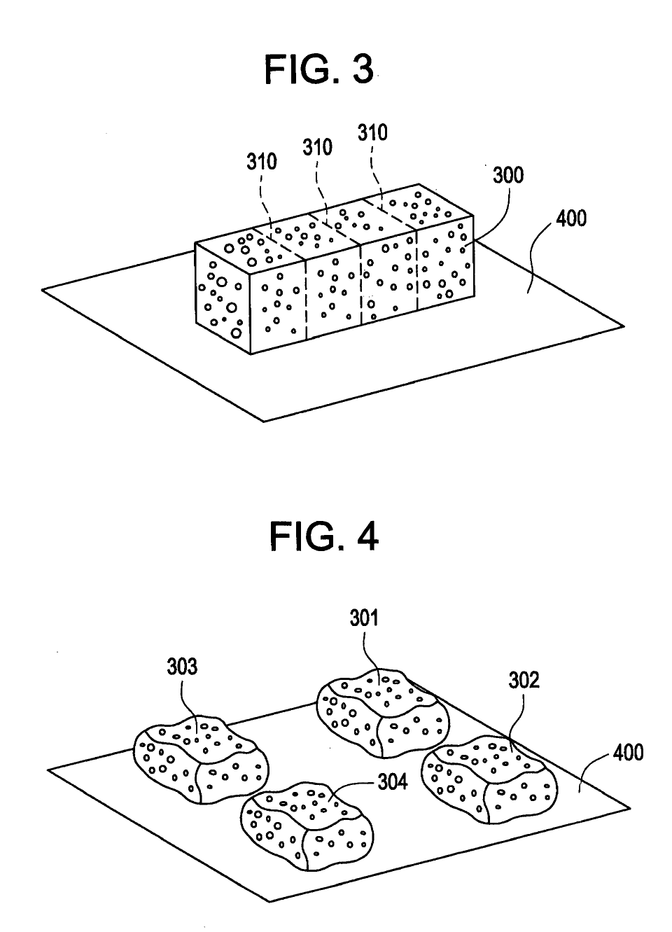

FIG. 3 shows the baking pack 200 of FIG. 2, wherein baking sheet 400 is unwrapped and ready-to-bake dough 300 is disposed on top of the baking sheet. In a most preferred embodiment of the invention, the baking pack 200 comprises approximately four ounces of ready-to-bake cookie dough configured to be cut into four one-ounce dough pieces for baking into individual cookies. As shown in FIG. 3, ready-to-bake dough 300 may be configured to be cut or broken into four individual cookie sized portions by providing score lines 310 in the dough. Alternately, grooves or combinations of grooves and score lines may be provided in ready-to-bake dough 300 to facilitate forming the dough into ready for baking dough pieces by breaking or pulling apart without further manipulation by the user. It is to be understood that in other embodiments, the dough is simply divided into pieces with a knife without scoring or grooves.

During use of the baking pack of embodiments of the present invention, a toaster oven is set to a suitable temperature, for example about 350 degrees Fahrenheit. Because a toaster oven can achieve a desired temperature in a very short time, virtually no pre-heat time is required. A baking pack of the present invention is unwrapped to separate the ready-to-bake dough from the baking sheet and the baking sheet retained. In a preferred embodiment, the ready-to-bake dough is cut into four even slices that are arranged approximately two inches apart on the flattened baking sheet for baking. Alternately, the dough can be thawed prior to removal from the baking sheet. The baking sheet and dough are placed in the toaster oven and baked for approximately 10-14 minutes or until golden brown. The baked goods are preferably cooled slightly before consumption, preferably for about two minutes. It is to be understood that other temperatures and baking times may be used according the baking conditions and particular dough being baked.

In a preferred embodiment in which about four ounces of cookie dough is provided, the dough can be divided into four one-ounce single cookie serving portions. FIG. 4 shows the baking pack 200 of FIG. 3, wherein dough pieces 301-304 are arranged on the baking sheet 400 and ready for cooking in a toaster oven.

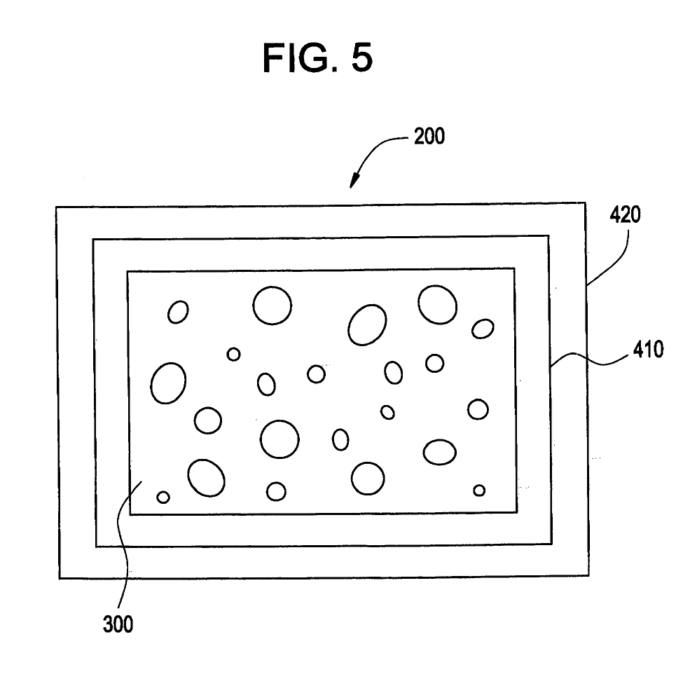

FIG. 5 shows a cross-sectional view of a baking pack according to another embodiment of the present invention. In this embodiment, baking pack 200 comprises ready-to-bake dough 300, an inner wrap 410, and an outer wrap 420. Preferably, inner wrap 410 is a baking sheet comprising silicone paper, aluminum foil, dark aluminum foil, stainless steel foil, a non-stick baking sheet, or laminates thereof, and the outer wrap is 420 is aluminum foil or other material suitable for packaging. In a preferred embodiment comprising a silicone paper inner wrap for use as a baking sheet and an outer wrap of metal foil, the metal foil reinforces the wrapped arrangement of the silicon paper, enabling the silicone paper to properly adhere to the dough in an airtight, stay-fresh manner and preventing unintentional unfolding of the baking sheet. When unwrapped and flattened, the silicone paper may be used as a baking sheet two or more times without burning. It is understood that the dimensions of the baking sheet may be proportioned such that opposite edges of the sheet overlap when wrapped about the block of dough to allow for larger baking surface. In embodiments of the present invention, a heat resistant material is used for the outer wrap even though the outer wrap is not intended to be disposed in the toaster oven. Optionally, the outer wrap 420 is provided with decorative and/or fanciful designs.

Alternately, the outer wrap 420 is a baking sheet comprising silicone paper, aluminum foil, dark aluminum foil, stainless steel foil, a non-stick baking sheet, or laminates thereof, and the inner wrap 410 is aluminum foil or other material suitable for protecting the dough from air and moisture. In either case, the baking sheet is configured to be flattened and received in a toaster oven. In baking pack 200, the amount of ready-to-bake dough 300 and the dimensions of the baking sheet are proportioned such that when the ready-to-bake dough 300 is wrapped, the dough is contained in the inner wrap 410 and outer wrap 420, and when the dough is unwrapped and formed into one ore more dough pieces, the dough pieces may be arranged on the baking sheet for baking.

Because the amount of ready-to-bake dough individually wrapped in the integrated baking sheet provides for small or individual portions of fresh baked goods, the need to refrigerate opened but unused dough is significantly diminished. It is to be understood, however, that in embodiments of the invention, the inner or outer wraps can be used to wrap and refrigerate unused dough when less than the full complement of baked goods provided for in a baking pack are desired. Alternately, the baking sheet itself can be used to wrap and refrigerate the remaining dough.

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A baking pack, comprising:
ready-to-bake refrigerated or frozen cookie dough; and
an integrated baking sheet configured to be flattened and received in a toaster oven, the dough being wrapped in the baking sheet;
wherein the amount of dough and the dimensions of the baking sheet are proportioned such that when the dough is wrapped, the dough is contained in the baking sheet, and when the dough is unwrapped and formed into one or more dough pieces, the dough pieces may be arranged on the baking sheet for baking.

2. The baking pack claimed in claim 1, wherein the dough is substantially parallelepipedal in shape with a length of between about 4 to about 6 inches, a height of about 1 to about 1.5 inches, and a width of about 1 to 1.5 inches.

3. The baking pack as claimed in claim 1, wherein each baking pack comprises about three to five ounces of dough.

4. The baking pack claimed in claim 1, wherein the dough is configured to be divided into individual pieces of predetermined size.

5. The baking pack claimed in claim 1, wherein the integrated baking sheet comprises aluminum foil, stainless steel foil, silicone paper, a non-stick baking sheet, or a laminate thereof.

6. The baking pack claimed in claim 1, further comprising an inner wrap, wherein the dough is first wrapped in the inner wrap, and then wrapped in the integrated baking sheet.

7. The baking pack claimed in claim 1, further comprising an outer wrap, wherein the dough is first wrapped in the integrated baking sheet, and then wrapped in the outer wrap.

8. The baking pack claimed in claim 7, wherein the integrated baking sheet is silicone paper and the outer wrap is metal foil.

9. The baking pack claimed in claim 1, wherein the baking sheet is rectangular in shape with a length of between about 5 to about 7 inches and a width of about 4 to about 6 inches.

10. A baking pack comprising ready-to-bake dough in an amount to make a small or individual portion of baked goods and an integrated baking sheet of flexible material, the dough being wrapped in the baking sheet, wherein the amount of dough and the dimensions of the baking sheet are proportioned such that when the dough is wrapped, the dough is contained in the baking sheet, and when the dough is unwrapped and formed into one or more dough pieces and the baking sheet flattened, the dough pieces may be arranged on the baking sheet for baking.

11. A process of preparing packaged dough integrated with a baking sheet, comprising:
providing ready-to-bake dough in an amount to make a small or individual portion of cookies; and
wrapping the dough in a flexible baking sheet;
wherein the amount of dough and the dimensions of the baking sheet are proportioned such that when the dough is wrapped, the dough is contained in the baking sheet, and when the dough is unwrapped and formed into one or more dough pieces and the baking sheet flattened, the dough pieces may be arranged on the baking sheet for baking.

12. A ready for baking dough product, comprising:
a carton; and
a plurality of baking packs received in the carton, each baking pack comprising an integrated baking sheet configured to be flattened and received in a toaster oven and ready-to-bake refrigerated or frozen dough, the dough being wrapped in the baking sheet, wherein the amount of dough and the dimensions of the baking sheet are proportioned such that when the dough is wrapped, the dough is contained in the baking sheet, and when the dough is unwrapped and divided into dough pieces, the dough pieces may be arranged on the baking sheet for baking.

13. The baking pack claimed in claim 12, wherein the dough comprising each baking pack is substantially parallelepipedal in shape with a length of between about 4 to about 6 inches, a height of about 1 to about 1.5 inches, and a width of about 1 to 1.5 inches.

14. The baking pack as claimed in claim 12, wherein each baking pack comprises about three to five ounces of dough.

15. The baking pack claimed in claim 12, wherein the dough comprising each baking pack is configured to be divided into individual pieces of predetermined size.

16. The baking pack claimed in claim 12, wherein the integrated baking sheet comprising each baking pack comprises aluminum foil, stainless steel foil, silicone paper, a non-stick baking sheet, or a laminate thereof.

17. The baking pack claimed in claim 12, wherein each baking pack further comprises an inner wrap, wherein the dough is first wrapped in the inner wrap, and then wrapped in the integrated baking sheet.

18. The baking pack claimed in claim 12, wherein each baking pack further comprises an outer wrap, wherein the dough is first wrapped in the integrated baking sheet, and then wrapped in the outer wrap.

19. The baking pack claimed in claim 18, wherein the integrated baking sheet is silicone paper and the outer wrap is metal foil.

20. The baking pack claimed in claim 12, wherein the baking sheet comprising each baking pack is rectangular in shape with a length of between about 5 to about 7 inches and a width of about 4 to about 6 inches.

21. The baking pack as claimed in claim 12, wherein the dough is cookie dough.
